(19) United States
(12) Patent Application Publication
(10) Pub. No.: US 2026/0120695 A1
(43) Pub. Date: Apr. 30, 2026

(54) METHOD OF OBTAINING USER INFORMATION AND ELECTRONIC DEVICE PERFORMING METHOD

(71) Applicant: SAMSUNG ELECTRONICS CO., LTD., Suwon-si (KR)

(72) Inventors: Suneung PARK, Suwon-si (KR); Hyunju SEO, Suwon-si (KR); Sanghee KIM, Suwon-si (KR); Inchul HWANG, Suwon-si (KR)

(73) Assignee: SAMSUNG ELECTRONICS CO., LTD., Suwon-si (KR)

(21) Appl. No.: 19/434,709

(22) Filed: Dec. 29, 2025

Related U.S. Application Data
(63) Continuation of application No. PCT/KR2024/008106, filed on Jun. 13, 2024.

(30) Foreign Application Priority Data
Jul. 21, 2023 (KR) 10-2023-0095603
Jun. 27, 2023 (KR) 10-2023-0082927

(51) Int. Cl. G10L 15/22; G06F 21/31; G06F 21/62

(52) U.S. Cl. CPC G10L 15/22; G06F 21/31; G06F 21/6245; G10L 2015/223

(57) ABSTRACT

Disclosed are a method of obtaining user information and an electronic device performing the method. The electronic device obtains a voice signal from a user, transmits, to a plurality of external electronic devices, a notification signal indicating that the electronic device is in an on-boarding process; obtain, from the plurality of external electronic devices, an information list related to user information for the on-boarding process. identifies an external electronic device, among the plurality of external electronic devices, from which to request the user information, based on the information list and a set policy, transmits a request to transmit the user information to the identified external electronic device, and obtains the user information from the identified external electronic device.

### CROSS-REFERENCE TO RELATED APPLICATIONS

This application is a continuation of International Application No. PCT/KR2024/008106, filed on June 13, 2024, and claiming priority to Korean Patent Application No. 10-2023-0082927, filed on June 27, 2023, in the Korean Intellectual Property Office, and Korean Patent Application No. 10-2023-0095603, filed on July 21, 2023, in the Korean Intellectual Property Office, the disclosures of each of which are incorporated by reference herein in their entireties.

### BACKGROUND

### 1. Field

The disclosure relates to a method of obtaining user information and an electronic device performing the method.

### 2. Description of Related Art

When an electronic device includes a voice assistant function, a user may perform an on-boarding process, such as registering an account, agreeing to the terms of service, and setting basic services, before using the voice assistant function for the first time.

After completing the on-boarding process, the user may use the voice assistant function of the electronic device. Since the process for registering user information, such as on-boarding, may be required identically for each device, when the user uses a plurality of electronic devices, the user may have to repeat the on-boarding process for each device.

In particular, in devices with limited input methods, such as a television (TV), the user may have difficulty inputting user information during the on-boarding process.

### SUMMARY

According to an aspect of the disclosure, there is provided an electronic device comprising: memory storing instructions; and at least one processor, wherein the instructions, when executed by the at least one processor, cause the electronic device to: obtain a voice signal from a user; transmit, to a plurality of external electronic devices, a notification signal indicating that the electronic device is in an on-boarding process; obtain, from the plurality of external electronic devices, an information list related to user information for the on-boarding process; identify an external electronic device, among the plurality of external electronic devices, from which to request the user information, based on the information list and a set policy; transmit a request to transmit the user information to the identified external electronic device; and obtain the user information from the identified external electronic device.

The instructions, when executed by the at least one processor, may cause the electronic device to obtain the information list related to the user information, based on a result of identifying, by the plurality of external electronic devices, whether a user registered in the plurality of external electronic devices is a same user as the user.

The instructions, when executed by the at least one processor, may cause the electronic device to, based on the user being the same user as the user registered in the plurality of external electronic devices, obtain the information list from the plurality of external electronic devices.

The instructions, when executed by the at least one processor, may cause the electronic device to: based on the user being different from the user registered in the plurality of external electronic devices, transmit a user authentication request to the plurality of external electronic devices; and obtain the information list related to the user information based on user authentication by the plurality of external electronic devices based on the user authentication request.

The instructions, when executed by the at least one processor, may cause the electronic device to: identify a priority based on a type of the electronic device and types of the plurality of external electronic devices, based on the set policy; and identify the external electronic device from which to request the user information, based on the priority.

The instructions, when executed by the at least one processor, may cause the electronic device to: control a display module (160) to provide an interface for conducting the on-boarding process; and transmit the notification signal based on the voice signal obtained while the interface is provided in the display module.

According to an aspect of the disclosure, there is provided an electronic device comprising: memory storing instructions; and at least one processor, wherein the instructions, when executed by the at least one processor, cause the electronic device to: obtain a voice signal from a user; obtain a notification signal indicating that an external electronic device is in an on-boarding process; based on the notification signal being obtained, set a first mode to transmit user information for the on-boarding process to the external electronic device; in the first mode, transmit an information list related to the user information to the external electronic device; and based on a request to transmit the user information being obtained from the external electronic device, transmit the user information to the external electronic device.

The electronic device may include: a natural language platform configured to process the voice signal, wherein the instructions, when executed by the at least one processor, may cause the electronic device to: after transmitting the user information to the external electronic device, set a second mode to process the voice signal using the natural language platform.

The instructions, when executed by the at least one processor, may cause the electronic device to: obtain the notification signal from the external electronic device or a server communicatively connected to the electronic device.

According to an aspect of the disclosure, there is provided a method of obtaining user information, the method comprising: obtaining a voice signal from a user; transmitting, to a plurality of external electronic devices, a notification signal indicating that an electronic device is in an on-boarding process; obtaining , from the plurality of external electronic devices, an information list related to user information for the on-boarding process; identifying an external electronic device, among the plurality of external electronic devices, from which to request the user information, based on the information list and a set policy; transmitting a request to transmit the user information to the identified external electronic device; and obtaining the user information from the identified external electronic device.

The obtaining of the information list related to the user information comprises: obtaining the information list related to the user information, based on a result of identifying, by the plurality of external electronic devices, whether a user registered in the plurality of external electronic devices is a same user as the user.

The obtaining of the information list related to the user information comprises: based on the user being the same user as the user registered in the plurality of external electronic devices, obtaining the information list from the plurality of external electronic devices.

The obtaining of the information list related to the user information comprises: based on the user being different from the user registered in the plurality of external electronic devices, transmitting a user authentication request to the plurality of external electronic devices); and obtaining the information list related to the user information based on user authentication by the plurality of external electronic devices based on the user authentication request.

The identifying of the external electronic device from which to request the user information may include: identifying a priority based on a type of the electronic device and types of the plurality of external electronic devices, based on the set policy; and identifying the external electronic device from which to request the user information, based on the priority.

The method may include: controlling a display module to provide an interface for conducting the on-boarding process, wherein the transmitting of the notification signal to the plurality of external electronic devices may include: transmitting the notification signal based on the voice signal obtained while the interface is provided in the display module.

A non-transitory computer readable medium may have recorded thereon a program for executing a method of obtaining user information.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a block diagram illustrating an electronic device in a network environment, according to various embodiments.

FIG. 2 is a block diagram illustrating an integrated intelligence system according to an embodiment.

FIG. 3 is a diagram illustrating a form in which relationship information on relationships between concepts and actions is stored in a database, according to an embodiment.

FIG. 4 is a diagram illustrating a screen of a user terminal processing a received voice input through an intelligent app, according to an embodiment.

FIG. 5 is a diagram illustrating an operation in which an electronic device receives user information from a plurality of external electronic devices, according to various embodiments.

FIG. 6 is a flowchart illustrating an operation of an electronic device performing a method of obtaining user information, according to various embodiments.

FIG. 7 is a diagram illustrating an operation of an electronic device establishing communication with a plurality of external electronic devices, according to various embodiments.

FIG. 8 is a flowchart illustrating an operation of an electronic device and a plurality of external electronic devices, according to various embodiments.

FIG. 9 is a diagram illustrating an operation of an electronic device and a plurality of external electronic devices identifying that the electronic device is performing an on-boarding process based on information received from a server, according to various embodiments.

FIG. 10 is a diagram illustrating an operation in which an electronic device transmits user information to an external electronic device, according to various embodiments.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

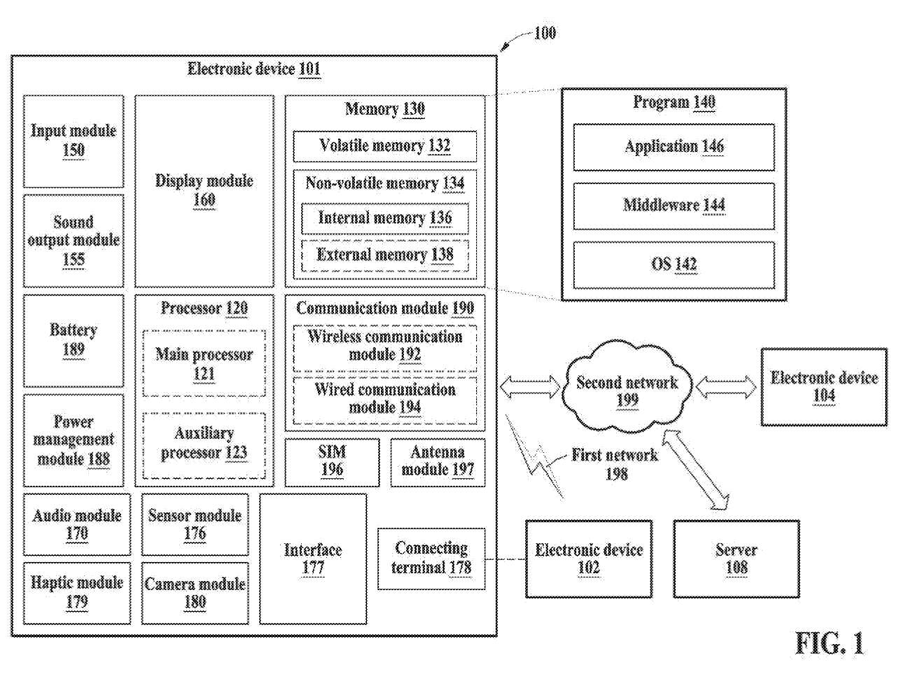

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state or together with the main processor 121 while the main processor 121 is in an active state (e.g., executing an app). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof but is not limited thereto. The artificial intelligence model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive (or obtain) a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102 such as a speaker or headphones) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via their tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as or a different type from the electronic device 101. According to an embodiment, all or some of operations to be executed at the electronic device 101 may be executed at one or more of the external electronic devices (e.g., the external devices 102 and 104, or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

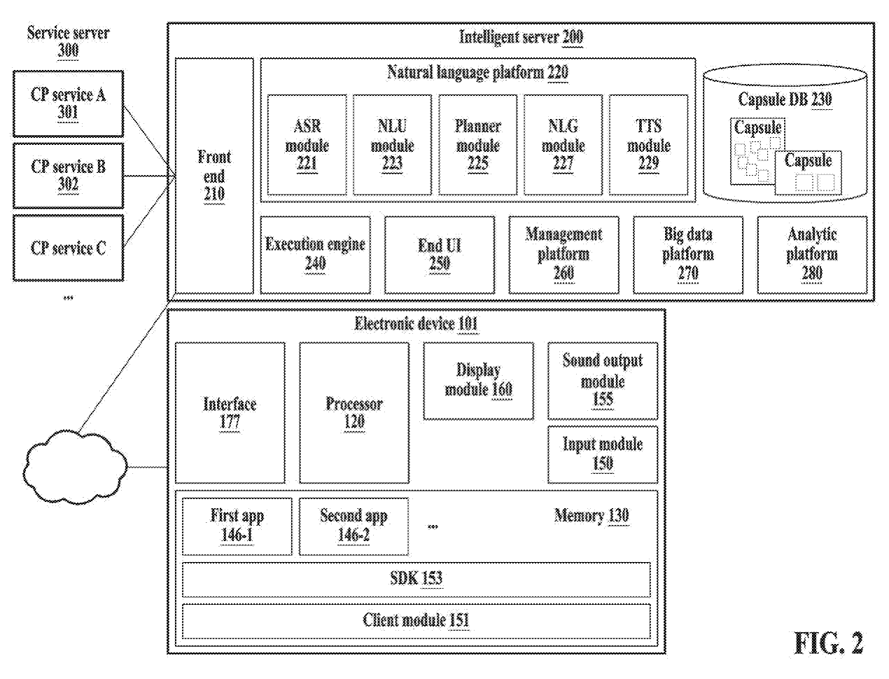

FIG. 2 is a block diagram illustrating an integrated intelligence system according to an embodiment.

Referring to FIG. 2, an integrated intelligence system of an embodiment may include the electronic device 101, an intelligent server 200, and a service server 300.

The electronic device 101 may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), or a smart speaker.

According to the illustrated embodiment, the electronic device 101 may include the interface 177, the input module 150, the audio output module 155, the display module 160, the memory 130, or the processor 120. The components listed above may be operationally or electrically connected to each other.

The interface 177 may be connected to an external device and configured to transmit and receive data to and from the external device. The input module 150 may receive a sound (e.g., a user utterance) and convert the sound into an electrical signal. The audio output module 155 may output an electrical signal as a sound (e.g., a voice). The display module 160 may be configured to display an image or video. The display module 160 may also display a graphical user interface (GUI) of an app (or an application program) being executed.

The memory 130 may store the client module 151, the SDK 153, and a plurality of apps 146. The client module 151 and the SDK 153 may configure a framework (or a solution program) for performing general-purpose functions. In addition, the client module 151 or the SDK 153 may configure a framework for processing a voice input.

The plurality of apps 146 stored in the memory 130 may be programs for performing designated functions. The plurality of apps 146 may include a first app 146-1 and a second app 146-2. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the interface 177, the input module 150, the audio output module 155, and the display module 160 to perform a designated operation.

The processor 120 may also perform the designated function by executing the program stored in the memory 130. For example, the processor 120 may execute at least one of the client module 151 or the SDK 153 to perform the following operation for processing a voice input. The processor 120 may control the operation of the plurality of apps 146 through, for example, the SDK 153. The following operation described as an operation of the client module 151 or the SDK 153 may be performed by the processor 120.

The client module 151 may receive a voice input. For example, the client module 151 may receive a voice signal corresponding to a user utterance sensed through the input module 150. The client module 151 may transmit the received voice input to the intelligent server 200. The client module 151 may transmit state information of the electronic device 101 together with the received voice input to the intelligent server 200. The state information may be, for example, execution state information of an app.

The client module 151 may receive a result corresponding to the received voice input. For example, when the intelligent server 200 is capable of calculating a result corresponding to the received voice input, the client module 151 may receive the result corresponding to the received voice input. The client module 151 may display the received result on the display module 160.

The client module 151 may receive a plan corresponding to the received voice input. The client module 151 may display results of executing a plurality of actions of an app according to the plan on the display module 160. The client module 151 may, for example, sequentially display the results of executing the plurality of actions on the display. As another example, the electronic device 101 may display only a partial result of executing the plurality of actions (e.g., a result of the last action) on the display.

According to an embodiment, the client module 151 may receive a request to obtain information necessary for calculating a result corresponding to the voice input from the intelligent server 200. According to an embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received voice input has been correctly processed using the information on the results.

The client module 151 may include a speech recognition module. According to an embodiment, the client module 151 may recognize a voice input for performing a limited function through the speech recognition module. For example, the client module 151 may execute an intelligent app for processing a voice input to perform an organic operation through a specified input (e.g., Wake up!).

The intelligent server 200 may receive information related to a user voice input from the electronic device 101 through a communication network. According to an embodiment, the intelligent server 200 may change data related to the received voice input into text data. According to an embodiment, the intelligent server 200 may generate a plan for performing a task corresponding to the user voice input based on the text data.

According to an embodiment, the plan may be generated by an artificial intelligence (AI) system. The AI system may be a rule-based system, or a neural network-based system (e.g., a feedforward neural network (FNN) or a recurrent neural network (RNN)). Alternatively, the AI system may be a combination of the above-described systems or other AI systems. According to an embodiment, the plan may be selected from a set of predefined plans or may be generated in real time in response to a user request. For example, the AI system may select at least one plan from among the predefined plans.

The intelligent server 200 may transmit a result according to the generated plan to the electronic device 101 or transmit the generated plan to the electronic device 101. According to an embodiment, the electronic device 101 may display the result according to the plan on the display. According to an embodiment, the electronic device 101 may display a result of executing an action according to the plan on the display.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received voice input from the electronic device 101. The front end 210 may transmit a response corresponding to the voice input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern an intent of a user using the text data of the voice input. For example, the NLU module 223 may discern the intent of the user by performing syntactic analysis or semantic analysis. The NLU module 223 may discern the meaning of a word extracted from the voice input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an embodiment, the planner module 225 may determine (or identify) a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the user intent. The planner module 225 may determine a relationship between the plurality of actions and the plurality of concepts stepwise (or hierarchically). For example, the planner module 225 may determine an execution order of the plurality of actions determined based on the user intent, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed into the text form may be in the form of a natural language utterance. The TTS module 229 may change information in a text form into information in a speech form.

According to an embodiment, some or all of the functions of the natural language platform 220 may be implemented in the electronic device 101 as well.

The capsule DB 230 may store information on the relationship between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining a single plan when there are a plurality of plans corresponding to the voice input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 101. According to an embodiment, the capsule DB 230 may include a vocabulary registry that stores vocabulary information included in capsule information. According to an embodiment, the capsule DB 230 may include a dialog registry that stores information on a dialog (or an interaction) with a user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with a user. The developer tool may include a follow-up editor capable of activating a subsequent goal and editing a subsequent utterance that provides hints. The subsequent goal may be determined based on a currently configured goal, a preference of a user, or environmental conditions. In an embodiment, the capsule DB 230 may also be implemented within the electronic device 101.

The execution engine 240 may calculate a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., a food order or hotel reservation) to the electronic device 101. According to an embodiment, the service server 300 may be a server operated by a third party. The service server 300 may provide information to be used for generating a plan corresponding to the received voice input to the intelligent server 200. The provided information may be stored in the capsule DB 230. In addition, the service server 300 may provide result information according to the plan to the intelligent server 200.

In the integrated intelligence system described above, the electronic device 101 may provide various intelligent services to the user in response to a user input. The user input may include, for example, an input through a physical button, a touch input, or a voice input.

In an embodiment, the electronic device 101 may provide a speech recognition service through an intelligent app (or a speech recognition app) stored therein. In this case, for example, the electronic device 101 may recognize a user utterance or a voice input received through the microphone, and provide a service corresponding to the recognized voice input to the user.

In an embodiment, the electronic device 101 may perform a designated action alone or together with the intelligent server and/or the service server, based on the received voice input. For example, the electronic device 101 may execute an app corresponding to the received voice input and perform a designated action through the executed app.

In an embodiment, when the electronic device 101 provides a service together with the intelligent server 200 and/or the service server, the user terminal may detect a user utterance using the input module 150 and generate a signal (or voice data) corresponding to the detected user utterance. The user terminal may transmit the voice data to the intelligent server 200 using the interface 177.

The intelligent server 200 may generate, as a response to the voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may be defined as parameters that are input for execution of the plurality of actions or result values that are output by execution of the plurality of actions. The plan may include connection information between the plurality of actions and the plurality of concepts.

The electronic device 101 may receive the response using the interface 177. The electronic device 101 may output a voice signal generated inside the electronic device 101 to the outside using the sound output module 155, or may output an image generated inside the electronic device 101 to the outside using the display module 160.

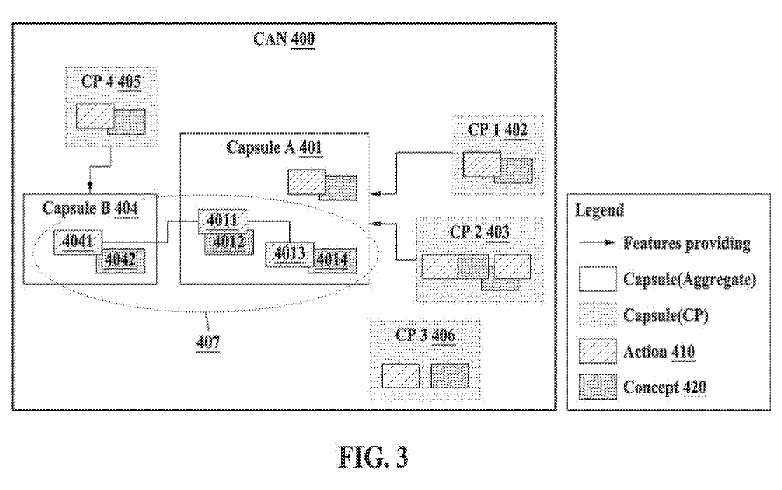

FIG. 3 is a diagram illustrating a form in which relationship information on relationships between concepts and actions is stored in a DB according to various embodiments.

A capsule DB (e.g., the capsule DB 230) of the intelligent server 200 may store capsules in the form of a CAN. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., apps). According to an embodiment, one capsule (e.g., the capsule A 401) may correspond to one domain (e.g., a location (geo) or an app). In addition, the one capsule may correspond to at least one service provider (e.g., CP 1402 or CP 2403) for performing a function for a domain related to the capsule. According to an embodiment, one capsule may include at least one action 410 for performing a designated function and at least one concept 420.

The natural language platform 220 may generate a plan for performing a task corresponding to the received voice input using the capsules stored in the capsule DB. For example, the planner module 225 of the natural language platform may generate the plan using the capsules stored in the capsule DB. For example, a plan 407 may be generated using actions 4011 and 4013 and concepts 4012 and 4014 of the capsule A 401 and an action 4041 and a concept 4042 of the capsule B 404.

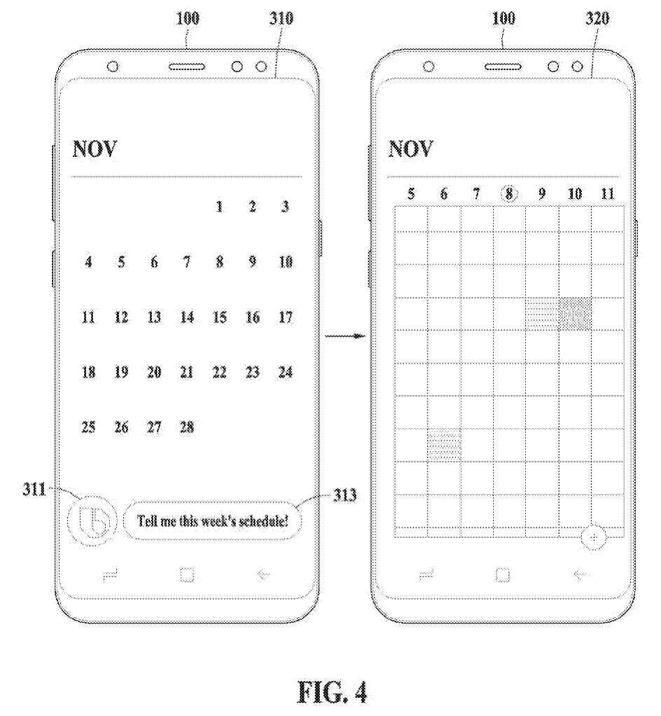

FIG. 4 is a diagram illustrating a screen of a user terminal processing a received voice input through an intelligent app according to various embodiments.

The electronic device 101 may execute an intelligent app to process a user input through the intelligent server 200.

According to an embodiment, on a screen 310, when (e.g., based on) a specified voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which a scheduling app is executed. According to an embodiment, the electronic device 101 may display an object (e.g., an icon) 311 corresponding to the intelligent app on the display module 160. According to an embodiment, the electronic device 101 may receive a voice input by a user utterance. For example, the electronic device 101 may receive a voice input of “Tell me this week’s schedule!”. According to an embodiment, the electronic device 101 may display a user interface (UI) 313 (e.g., an input window) of the intelligent app in which text data of the received voice input is displayed on the display.

According to an embodiment, on a screen 320, the electronic device 101 may display a result corresponding to the received voice input on the display. For example, the electronic device 101 may receive a plan corresponding to the received user input, and display “this week’s schedule” on the display according to the plan.

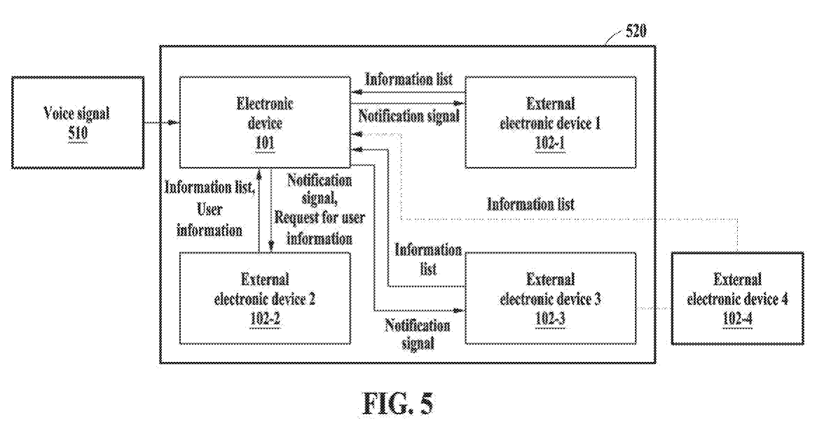

FIG. 5 is a diagram illustrating an operation in which the electronic device 101 (e.g., the electronic device 101 of FIGS. 1 and 2) according to various embodiments receives user information from a plurality of external electronic devices 102-1, 102-2, and 102-3 (e.g., the electronic device 101, the electronic device 102, and the electronic device 104 of FIG. 1).

Referring to FIG. 5, the electronic device 101 may receive a voice signal 510 from a user. For example, the electronic device 101 may receive the voice signal 510 from the user using a device (e.g., a microphone or a voice input device) included in an input module (e.g., the input module 150 of FIGS. 1 and 2).

The electronic device 101, external electronic device 1102-1, external electronic device 2102-2 and/or external electronic device 3102-3 may receive the voice signal 510 from the user. When the voice signal 510 of the user includes a wake up word, the electronic device 101, external electronic device 1102-1, external electronic device 2102-2, and/or external electronic device 3102-3 may identify the wake up word. When the wake up word is identified while an operating state is a sleep state or an idle state, the electronic device 101, external electronic device 1102-1, external electronic device 2102-2, and/or external electronic device 3102-3 may be switched to an active state. The electronic device 101, external electronic device 1102-1, external electronic device 2102-2, and/or external electronic device 3102-3 that identifies the wake up word may process a voice command received after the wake up word using a natural language platform (e.g., the natural language platform 220 of FIG. 2).

The electronic device 101 may receive the voice signal 510 from the user during an on-boarding process. For example, the on-boarding process may be a process for inputting user information to use the functions of the electronic device 101. When the electronic device 101 has input user information, such as an IoT device, the electronic device 101 may obtain user information through an on-boarding process. When the electronic device 101 includes a function that provides a service based on registered user information, such as a voice assistant function, the electronic device 101 may obtain user information through the on-boarding process.

For example, the user information may include communication connection information for on-boarding (e.g., a Wi-Fi password, Wi-Fi address, media access control (MAC) address, communication scheme, whether or not there is an external network connection, and the like), a location where the electronic device 101 is registered, room information, voice assistant setting information, permission information, TTS voice information, speaker information, and the like. The user information may include information required for user registration, information required for communication connection of the electronic device 101, as well as preference information (e.g., TTS voice information, speaker information, preferred voice, preferred video, preferred service, and the like) related to the function (e.g., voice assistant) of the electronic device 101.

Additionally, the user information may include setting values regarding the functions and/or operations of the electronic device 101 (e.g., voice sensitivity of the voice assistant, amount of response information, response scheme, and the like).

The user information is not limited to the examples described above, and may include various information required for use of the electronic device 101 and set by the user.

The electronic device 101 may transmit a notification signal indicating that the electronic device 101 is in an on-boarding process to the external electronic device 1102-1, external electronic device 2102-2, and/or external electronic device 3102-3. For example, the electronic device 101 may establish communication with the external electronic device 1102-1, external electronic device 2102-2, and/or external electronic device 3102-3. The electronic device 101 may transmit a notification signal to the external electronic device 1102-1, external electronic device 2102-2, and/or external electronic device 3102-3 to which it is communicatively connected. The electronic device 101 may be communicatively connected to the external electronic device 1102-1, external electronic device 2102-2, and/or external electronic device 3102-3 to form a local network 520. The communication connection scheme between the electronic device 101 and the external electronic device 1102-1, external electronic device 2102-2, and/or external electronic device 3102-3 may be applied using various short-range wireless network methods such as Bluetooth and Wi-Fi.

For example, the electronic device 101 may control a display module (e.g., the display module 160 of FIG. 1) to provide an interface for performing the on-boarding process. For example, the electronic device 101 may provide a screen through the display module that requests the user to utter a specified word or command. The specified word or command may include a wake up word.

The electronic device 101 may provide an interface that requests the user to utter the specified word or command using a scheme (e.g., voice output) other than the interface through the display module described above.

For example, an interface that allows the user to utter the specified word or command may be provided to the user by displaying guidance such as “If you wish to register as a user using information registered in a peripheral device, please say ‘XXX’” on the display module or as the voice signal 510.

The electronic device 101 may transmit the notification signal to the external electronic device 1102-1, external electronic device 2102-2, and/or external electronic device 3102-3 based on the voice signal 510 received while providing the interface (via the display module). For example, when the voice signal 510 received from the user while the interface is provided includes a requested word or command, the electronic device 101 may transmit the notification signal to the external electronic device 1102-1, external electronic device 2102-2, and/or external electronic device 3102 -3.

The external electronic device 1102-1, external electronic device 2102-2 and/or external electronic device 3102-3 may receive the notification signal from the electronic device 101. The external electronic device 1102-1, external electronic device 2102-2, and/or external electronic device 3102-3 may set the external electronic device 1102-1, external electronic device 2102-2, and/or external electronic device 3102-3 to a first mode, respectively, based on the received notification signal. For example, the first mode may be an operation mode for transmitting user information required for the on-boarding process to the electronic device 101.

For example, when the voice signal 510 including a wake up word is received, and the notification signal is received from the electronic device 101, the external electronic device 1102-1, external electronic device 2102-2 and/or external electronic device 3102-3 may set the external electronic device 1102-1, external electronic device 2102-2 and/or external electronic device 3102-3 to the first mode.

For example, when the voice signal 510 including the wake up word is received, and the notification signal is not received, the external electronic device 1102-1, external electronic device 2102-2 and/or external electronic device 3102-3 may set the external electronic device 1102-1, external electronic device 2102-2 and/or external electronic device 3102-3 to a second mode.

For example, the second mode may be an operation mode for the external electronic device 1102-1, external electronic device 2102-2, and/or external electronic device 3102-3 to process the voice signal 510 of the user using the natural language platform 220.

In the first mode, the external electronic device 1102-1, external electronic device 2102-2 and/or external electronic device 3102-3 may transmit an information list related to the user information to the electronic device 101.

For example, the information list may indicate the type of user information registered in the external electronic device 1102-1, external electronic device 2102-2, and/or external electronic device 3102-3. For example, the information list may include user information, a communication connection scheme, account information, device type, and the like registered for each of the external electronic device 1102-1, external electronic device 2102-2, and/or external electronic device 3102-3.

The electronic device 101 may receive the information list from the external electronic device 1102-1, external electronic device 2102-2, and/or external electronic device 3102-3.

As shown in FIG. 5, the electronic device 101 may transmit a notification signal to the external electronic device 1102-1, external electronic device 2102-2, and/or external electronic device 3102-3, and receive an information list from the external electronic device 1 102-1, external electronic device 2102-2, and/or external electronic device 3102-3.

For example, based on a result of determining, by the plurality of external electronic devices 102-1, 102-2, and 102-3, whether a user registered in the plurality of external electronic devices 102-1, 102-2, and 102-3 is the same as the user inputting the voice signal 510, the electronic device 101 may receive the information list related to the user information.

For example, when the external electronic device 1102-1, external electronic device 2102-2, and/or external electronic device 3102-3 determines that the user registered in each of the external electronic device 1102-1, external electronic device 2102-2, and/or external electronic device 3102-3 and the user uttering the voice signal 510 are the same, the electronic device 101 may receive the information list from the external electronic device 1102-1, external electronic device 2102-2, and/or external electronic device 3102-3.

For example, when a user registered in at least one of the plurality of external electronic devices 102-1, 102-2, and 102-3 is different from the user uttering the voice signal 510, the electronic device 101 may transmit a user authentication request to at least one of the plurality of external electronic devices 102-1, 102-2, and 102-3.

An external electronic device that receives the user authentication request may perform user authentication according to the user authentication request. For example, the external electronic device may perform the user authentication by receiving additional input from the user (e.g., inputting a password, inputting account information, and the like).

The electronic device 101 may receive the information list based on the user authentication of the external electronic device. For example, the electronic device 101 may receive the information list from one or more external electronic devices that have completed user authentication among one or more external electronic devices that have received the user authentication request.

The electronic device 101 may determine an external electronic device storing required user information as the device from which to request the user information. When there are two or more external electronic devices storing the required user information, the electronic device 101 may determine an external electronic device with a higher priority as the device from which to request the user information. The electronic device 101 may determine a device from which to request user information for each required user information.

The electronic device 101 may determine an external electronic device from which to request the user information among the plurality of external electronic devices 102-1, 102-2, and 102-3, based on the information list and a set policy.

For example, the electronic device 101 may determine the priority based on the type of the electronic device 101 and the types of the plurality of external electronic devices 102-1, 102-2, and 102-3, based on the policy. According to the policy, the priority of the plurality of external electronic devices 102-1, 102-2, and 102-3 of the same type as the type of the electronic device 101 may be set high.

For example, when the electronic device 101 is a TV, the priority of an external electronic device, which is a TV, may be set to be high.

The policy may include priorities of external electronic devices of the same type as the electronic device 101, as well as priorities of external electronic devices of a different type than the electronic device 101. For example, when the electronic device 101 is a TV, the policy may include priorities for other device types (e.g., a speaker, mobile, tablet, refrigerator, and the like). When the device type of the electronic device 101 is different from a TV (e.g., a speaker, mobile, tablet, refrigerator, and the like), the policy may include priorities according to the device types of the plurality of external electronic devices 102-1, 102-2, and 102-3 corresponding to the device type of each electronic device 101.

For example, when the device type of the electronic device 101 is a hub connected device, the priority of an external electronic device of a hub type may be set to the highest. For example, when the device type of the electronic device 101 is a cloud connected device, the priority of an external electronic device of a device type that stores information (e.g., Wi-Fi connection information) that may be connected to an access point (AP) may be set to the highest.

A high priority may be set for a device type similar to the device type of the electronic device 101. For example, when the electronic device 101 is a mobile, the priority of a tablet similar to the device type of the electronic device 101 may be set higher than the priority of a refrigerator that is not similar to the electronic device 101.

The description of the priorities included in the policy is only an example, and is not limited to the examples described above. The priorities may be set in various ways other than the examples described above. Additionally, the policy may include priorities determined based on the device type of the electronic device 101 and the external electronic device for each user information.

The electronic device 101 may determine the external electronic device from which to request the user information, based on the priority. For example, when the external electronic device 1102-1 has the highest priority among the plurality of external electronic devices 102-1, 102-2, and 102-3, and the external electronic device 1102-1 stores information required for the on-boarding process, the electronic device 101 may determine the external electronic device 1102-1 as the device from which to request the user information.

For example, when the external electronic device 2 102-2 and external electronic device 3102-3 do not store the required user information, and the external electronic device 1102-1 has the lowest priority among the plurality of external electronic devices 102-1, 102-2, and 102-3, the electronic device 101 may determine the external electronic device 1102-1, which stores the required user information, as the device from which to request the user information.

For example, when the external electronic device 1102-1 and external electronic device 2102-2 store the required user information, the electronic device 101 may determine the external electronic device with the highest priority among the external electronic device 1102-1 and external electronic device 2102-2 as the device from which to request the required user information.

For example, the electronic device 101 may determine one or more external electronic devices among the plurality of external electronic devices 102-1, 102-2, and 102-3 as the device from which to request the user information. For example, when user information A required for the on-boarding process is stored in the external electronic device 1102-1 and user information B required for the on-boarding process is stored in the external electronic device 2102-2, the electronic device 101 may determine the external electronic device 1102-1 and external electronic device 2102-2 as the device from which to request the user information.

The electronic device 101 may transmit a request to transmit the user information to the determined external electronic device. As shown in FIG. 5, when the external electronic device 2102-2 is determined to be the device from which to request the user information, the electronic device 101 may transmit a request to transmit the user information to the external electronic device 2102-2.

When the determined external electronic device receives a request to transmit the user information from the electronic device 101, the determined external electronic device may transmit the user information to the electronic device 101. As shown in FIG. 5, the external electronic device 2102-2 that receives the request to transmit the user information may transmit the user information to the electronic device 101.

For example, when there are two or more determined external electronic devices, the electronic device 101 may transmit a request to transmit the user information to each of the two or more external electronic devices. Each of the external electronic devices that receives the request to transmit the user information may transmit the requested user information to the electronic device 101.

For example, when two or more external electronic devices store the required user information, the electronic device 101 may provide an interface for receiving a user input. The electronic device 101 may determine which of the two or more external electronic devices from which to request the required user information, based on the user input received through the interface. The electronic device 101 may provide an interface for receiving a user input for each user information, and may determine respective devices from which to request user information for each user information, based on the user input.

For example, when two or more external electronic devices storing user information have the same priority, the electronic device 101 may provide an interface for receiving a user input.

For example, when two or more external electronic devices storing user information have different priorities, the electronic device 101 may provide the priorities of each external electronic device and provide an interface for receiving a user input.

The electronic device 101 may receive the user information from the determined external electronic device. The electronic device 101 may perform the on-boarding process based on the received user information. When additional information is required in addition to the received user information, the electronic device 101 may provide the user with an interface for receiving the additional information. The electronic device 101 may perform the on-boarding process using the additional information input by the user and the received user information.

As shown in FIG. 5, the electronic device 101 may receive an information list of an external electronic device 4102-4 from the external electronic device 4 102-4 that is not connected to the local network 520. For example, the external electronic device 4102-4 may establish communication with the external electronic device 3102-3. The external electronic device 4102-4 may receive a notification signal indicating that the electronic device 101 is in the on-boarding process through the external electronic device 3102-3. The external electronic device 4102-4 may transmit the information list to the electronic device 101 in response to the received notification signal. The external electronic device 4 102-4 may establish communication with the electronic device 101 and directly transmit the information list to the electronic device 101, or transmit the information list to the electronic device 101 through the external electronic device 3102-3.

After transmitting the information list to the electronic device 101, the external electronic device 4102-4 may operate substantially the same as the external electronic device 1102-1, external electronic device 2102-2, and/or external electronic device 3102-3. Therefore, a description is omitted with respect to the external electronic device 4102-4, and the description of the external electronic device 1102-1, external electronic device 2102-2, and/or external electronic device 3102-3 may be substantially equally applied to the external electronic device 4102-4.

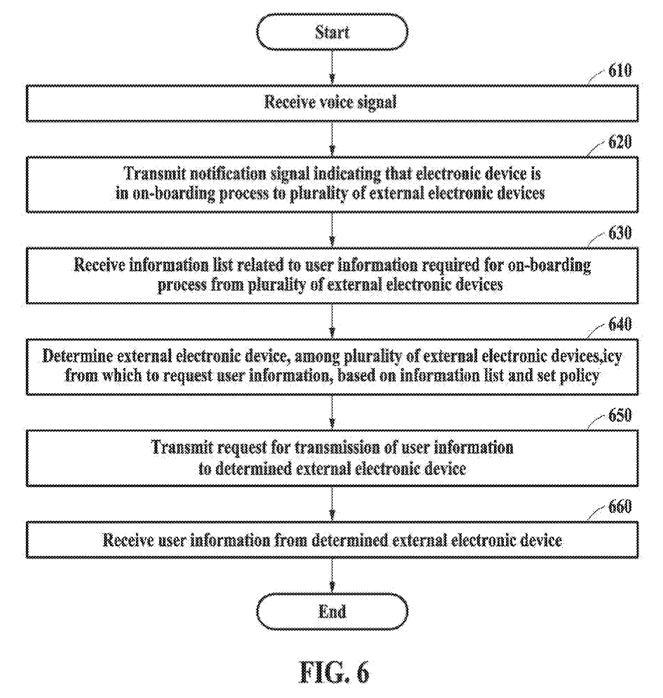

FIG. 6 is a flowchart illustrating an operation of an electronic device (e.g., the electronic device 101 of FIGS. 1, 2, and FIG. 5) performing a method of obtaining user information according to various embodiments.

In operation 610, the electronic device 101 may receive a voice signal. For example, the electronic device 101 may receive a voice signal from a user using a microphone included in an input module (e.g., the input module 150 of FIG. 1).

In operation 610, the electronic device 101 may receive the voice signal from a user while providing an interface requesting the user to utter a specified word or command.

In operation 620, the electronic device 101 may transmit a notification signal indicating that the electronic device 101 is in an on-boarding process to a plurality of external electronic devices (e.g., the electronic device 101, the electronic device 102, and the electronic device 104 of FIG. 1, and the plurality of external electronic devices 102-1, 102-2, and 102-3 of FIG. 5). For example, the electronic device 101 may transmit the notification signal to the plurality of external electronic devices 102-1, 102-2, and 102-3 communicatively connected to the electronic device 101.

An external electronic device receiving the notification signal may set the external electronic device to a first mode for transmitting user information. The external electronic device may transmit an information list related to the user information to the electronic device 101.

For example, when a user registered on the external electronic device and the user inputting the voice signal are the same, the external electronic device may transmit the information list. The external electronic device may use the voice signal to identify a speaker of the voice signal.

In operation 630, the electronic device 101 may receive an information list related to user information required for the on-boarding process from the plurality of external electronic devices 102-1, 102-2, and 102-3. The information list may include user information, a communication connection scheme, account information, and/or device type stored in each of the plurality of external electronic devices 102-1, 102-2, and 102-3.

In operation 640, the electronic device 101 may determine an external electronic device from which to request the user information among the plurality of external electronic devices 102-1, 102-2, and 102-3, based on the information list and a set policy. For example, the electronic device 101 may determine, among one or more external electronic devices including user information required for the on-boarding process, an external electronic device from which to request the user information, based on a priority included in the policy.

In operation 650, the electronic device 101 may transmit a request to transmit the user information to the determined external electronic device. In operation 640, when the electronic device 101 determines the external electronic device from which to request one or more user information, in operation 650, the electronic device 101 may transmit a transmission request to the external electronic device from which to request the one or more user information.

In operation 660, the electronic device 101 may receive the user information from the determined external electronic device. The electronic device 101 may perform the on-boarding process using the received user information. The electronic device 101 may perform the on-boarding process by obtaining user information stored in the external electronic device based on the user’s voice input without receiving the user information directly from the user.

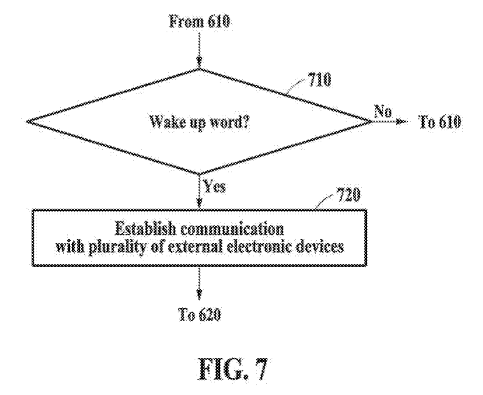

FIG. 7 is a diagram illustrating an operation of an electronic device (e.g., the electronic device 101 of FIGS. 1, 2, and FIG. 5) establishing communication with a plurality of external electronic devices (e.g., the electronic device 101, the electronic device 102, and the electronic device 104 of FIG. 1, and the plurality of external electronic devices 102-1, 102-2, and 102-3 of FIG. 5), according to various embodiments.

In operation 710, the electronic device 101 may determine whether the voice signal includes a wake up word. In operation 710, the electronic device 101 may provide an interface requesting a user to utter a specified word or command (e.g., a wake up word), and may determine whether the voice signal received while providing the interface includes the specified word or command.

In operation 710, when it is determined that the voice signal includes a wake up word, the electronic device 101 may establish communication with the plurality of external electronic devices 102-1, 102-2, and 102-3. The electronic device 101 and the plurality of external electronic devices 102-1, 102-2, and 102-3 may be connected to each other through communication, thereby forming a local network (e.g., the local network 520 of FIG. 5).

The electronic device 101 and/or the plurality of external electronic devices 102-1, 102-2, and 102-3 may transmit and/or receive data such as a notification signal, information list, request for transmission of user information, and user information via the local network 520.

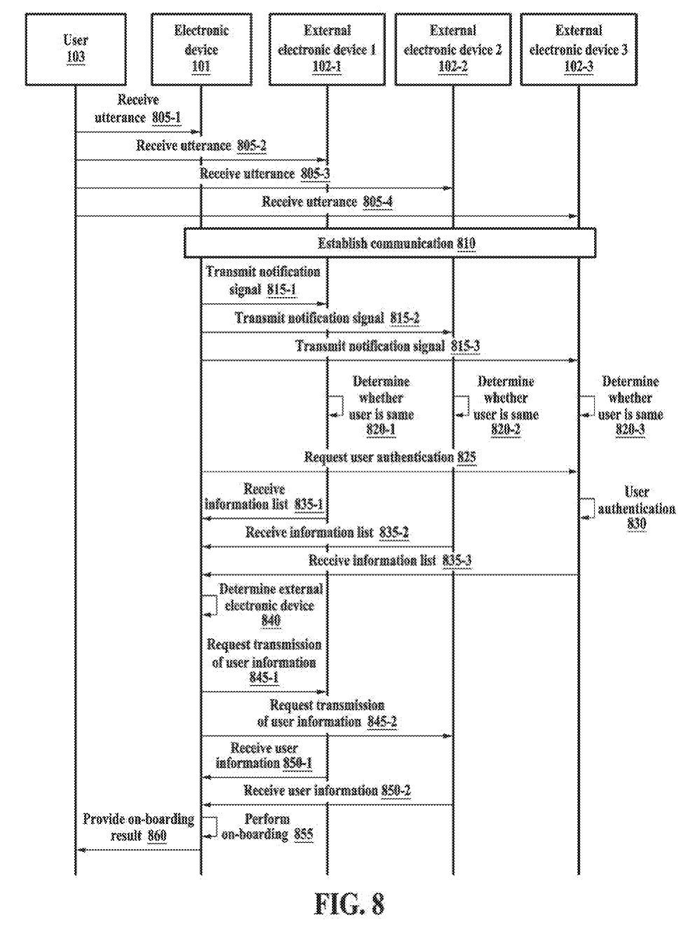

FIG. 8 is a flowchart illustrating an operation of the electronic device 101 (e.g., the electronic device 101 of FIGS. 1, 2, AND FIG. 5) and the plurality of external electronic devices 102-1, 102-2, and 102-3 (e.g., the electronic device 101, the electronic device 102, and the electronic device 104 of FIG. 1, and the plurality of external electronic devices 102-1, 102-2, and 102-3 of FIG. 5), according to various embodiments.

The electronic device 101 may receive an utterance from a user 103 in operation 805-1. The external electronic device 1 102-1 may receive the utterance from the user 103 in operation 805-2. The external electronic device 2102-2 may receive the utterance from the user 103 in operation 805-3. The external electronic device 3102-3 may receive the utterance from the user 103 in operation 805-4.

The electronic device 101, external electronic device 1102-1, external electronic device 2102-2 and/or external electronic device 3102-3 may be communicatively connected to each other in operation 810. The electronic device 101, the external electronic device 1102-1, external electronic device 2102-2, and/or external electronic device 3102-3 may be communicatively connected to each other to form a local network (e.g., the local network 520 of FIG. 5).

The electronic device 101 may transmit a notification signal to the external electronic device 1102-1 in operation 815-1. The electronic device 101 may transmit the notification signal to the external electronic device 2102-2 in operation 815-2. The electronic device 101 may transmit the notification signal to the external electronic device 3102-3 in operation 815-3.

The external electronic device 1102-1, external electronic device 2102-2 and/or external electronic device 3102-3 that receive the notification signal may be set to a first mode for transmitting user information.

The external electronic device 1102-1 may determine whether a user is the same in operation 820-1. The external electronic device 1102-1 may determine whether a user registered in the external electronic device 1102-1 and the user 103 uttering the voice signal in operation 805-2 are the same.

The external electronic device 2102-2 may determine whether a user is the same in operation 820-2. The external electronic device 2102-2 may determine whether a user registered in the external electronic device 2102-2 and the user 103 uttering the voice signal in operation 805-3 are the same.

The external electronic device 3102-3 may determine whether a user is the same in operation 820-3. The external electronic device 3102-3 may determine whether a user registered in the external electronic device 3102-3 and the user 103 uttering the voice signal in operation 805-4 are the same.

Based on a result of determining, by the plurality of external electronic devices 102-1, 102-2, and 102-3, whether the user registered in the plurality of external electronic devices 102-1, 102-2, and 102-3 is the same as the user, the electronic device 101 may receive the information list related to the user information.

FIG. 8 is a diagram showing an example where the user 103 inputting the voice signal is the same as the user registered in the external electronic device 1102-1 and external electronic device 2102-2, and the user registered in the external electronic device 3102-3 is different from the user 103 inputting the voice signal.

The electronic device 101 may receive the information list from the plurality of external electronic devices 102-1, 102-2, and 102-3 when the user is the same as the user registered in the plurality of external electronic devices 102-1, 102-2, and 102-3.

When it is determined that the user registered in the external electronic device 1102-1 and the user 103 inputting the voice signal are the same in operation 820-1, the electronic device 101 may receive the information list from the external electronic device 1102-1 in operation 835-1.

When it is determined that the user registered in the external electronic device 2102-2 and the user 103 inputting the voice signal are the same in operation 820-2, the electronic device 101 may receive the information list from the external electronic device 2102-2 in operation 835-2.

The electronic device 101 may transmit a user authentication request to the plurality of external electronic devices 102-1, 102-2, and 102-3 when the user is different from the users registered in the plurality of external electronic devices 102-1, 102-2, and 102-3.

When it is determined that the user registered in the external electronic device 3102-3 and the user 103 inputting the voice signal are not the same in operation 820-3, the electronic device 101 may transmit a user authentication request to the external electronic device 3102-3 in operation 830.

For example, the external electronic device 1102-1, external electronic device 2102-2, and/or external electronic device 3102-3 may identify a speaker of the voice signal and determine whether the identified speaker is the same as the registered user.

The external electronic device 3102-3 that receives the user authentication request may perform user authentication in operation 830. For example, the external electronic device 3102-3 may receive additional information from the user, such as a password input, account information input, and biometric information input, and use the received information to confirm that the user is registered with the external electronic device 3102-3.

The electronic device 101 may receive the information list related to the user information, based on user authentication by the plurality of external electronic devices 102-1, 102-2, and 102-3.

When the user authentication is completed in operation 830, the electronic device 101 may receive the information list from the external electronic device 3102-3 in operation 835-3.

In operation 840, the electronic device 101 may determine an external electronic device from which to request the user information. For example, the electronic device 101 may determine an external electronic device from which to request the user information based on the information list and a set policy. The electronic device 101 may determine an external electronic device from which to request the user information among one or more external electronic devices storing required user information.

When there are two or more external electronic devices storing the required user information, the electronic device 101 may determine the external electronic device from which to request the user information, based on a priority included in the policy. For example, a device type same as the device type of the electronic device 101 may be determined to have a high priority.

The electronic device 101 may determine the external electronic device from which to request the user information based on the user information. For example, when the external electronic device 1102-1 and external electronic device 2102-2 store user information A and user information B required for the on-boarding process, respectively, the electronic device 101 may determine the external electronic device from which to request the user information A to be the external electronic device 1102-1, and the external electronic device from which to request the user information B to be the external electronic device 2102-2. In the example described above, the electronic device 101 may determine the external electronic devices from which to request the user information A and user information B, respectively, based on the priorities for the user information A and user information B, respectively.

FIG. 8 illustrates an example in which the external electronic device 1102-1 and external electronic device 2102-2 are determined as the external electronic devices from which to request the user information in operation 840. The electronic device 101 may transmit a request to transmit the user information to the external electronic device 1102-1 in operation 845-1. The electronic device 101 may transmit a request to transmit the user information to the external electronic device 2102-2 in operation 845-2.

In response to the transmission request in operation 845-1, the electronic device 101 may receive the user information from the external electronic device 1102-1 in operation 850-1. In response to the transmission request in operation 845-2, the electronic device 101 may receive the user information from the external electronic device 2102-2 in operation 850-2.

In operation 855, the electronic device 101 may perform the on-boarding process using the received user information.

In operation 860, the electronic device 101 may provide on-boarding results to the user 103. For example, when the on-boarding process is completed using the received user information, the electronic device 101 may provide information related to the completed on-boarding process (e.g., registered user information, account information, preference information, and the like) to the user 103 in operation 860.

For example, when additional information is required in addition to the user information received during the on-boarding process, the electronic device 101 may provide an interface for receiving additional user information from the user 103 in operation 860.

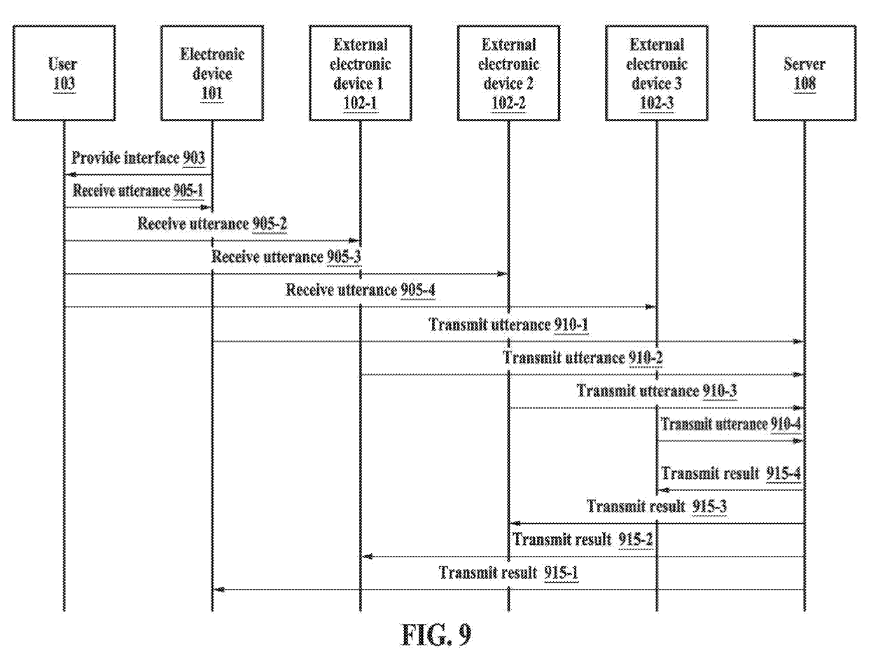

FIG. 9 is a diagram illustrating an operation of the electronic device 101 (e.g., the electronic device 101 of FIGS. 1, 2, and 5) and the plurality of external electronic devices 102-1, 102-2, and 102-3 (e.g., the electronic device 101, the electronic device 102, the electronic device 104 of FIG. 1, and the plurality of external electronic devices 102-1, 102-2, and 102-3 of FIGS. 5 and 8) identifying that the electronic device 101 is performing an on-boarding process based on information received from a server (e.g., the server 108 of FIG. 1, the intelligent server 200 of FIG. 2), according to various embodiments.

In FIG. 9, the external electronic device 1102-1, external electronic device 2102-2, and/or external electronic device 3102-3 may identify that the electronic device 101 is in an on-boarding process based on a result received from the server 108.

In operation 903, the electronic device 101 may provide an interface to the user 103. For example, the electronic device 101 may provide an interface that requests the user 103 to utter a specified word or command when the user desires to proceed with the on-boarding process using user information stored in the plurality of external electronic devices 102-1, 102-2, and 102-3.

For example, the electronic device 101 may control a display module (e.g., the display module 160 of FIG. 1) to provide an interface displayed on a screen, or control an audio output module (e.g., the audio output module 155 of FIG. 1) to provide an interface output as a voice.

The electronic device 101 may receive an utterance from the user 103 in operation 905-1. The external electronic device 1102-1 may receive the utterance from the user 103 in operation 905-2. The external electronic device 2102-2 may receive the utterance from the user 103 in operation 905-3. The external electronic device 3102-3 may receive the utterance from the user 103 in operation 905-4.

In operation 910-1, the electronic device 101 may transmit the utterance (e.g., a voice signal) to the server 108. In operation 910-1, the electronic device 101 may transmit information to the server 108 indicating that the electronic device 101 is in the on-boarding process.

In operation 910-2, the external electronic device 1 102-1 may transmit the utterance to the server 108. In operation 910-3, the external electronic device 2102-2 may transmit the utterance to the server 108. In operation 910-4, the external electronic device 3102-3 may transmit the utterance to the server 108.

The server 108 may identify that the electronic device 101 is performing the on-boarding process using the utterance and information received from the electronic device 101, external electronic device 1102-1, external electronic device 2102-2, and external electronic device 3102-3. For example, the server 108 may determine that the electronic device 101 is in the on-boarding process based on the magnitude (e.g., signal-to-noise ratio (SNR)) of the voice signal received from the electronic device 101, external electronic device 1102-1, external electronic device 2102-2, and external electronic device 3102-3 and the information received from the electronic device 101.

When the user 103 speaks in proximity to the electronic device 101, the magnitude of the voice signal received by the electronic device 101 may be the greatest among the magnitudes of the voice signals received by the electronic device 101, external electronic device 1102-1, external electronic device 2102-2, and external electronic device 3102-3.

When the signal indicating that the electronic device 101 is in the on-boarding process is received from the electronic device 101, and the magnitude of the voice signal received by the electronic device 101 is the greatest among the magnitudes of the voice signals received by the electronic device 101, external electronic device 1102-1, external electronic device 2102-2, and external electronic device 3102-3, the server 108 may determine that an intention of the user utterance received in operation 905-1, operation 905-2, operation 905-3, and operation 905-4 is to perform an on-boarding process for the electronic device 101.

In operation 915-1, the server 108 may transmit a result to the electronic device 101. In operation 915-2, the server 108 may transmit the result to the external electronic device 1102-1. In operation 915-3, the server 108 may transmit the result to the external electronic device 2102-2. In operation 915-4, the server 108 may transmit the result to the external electronic device 3102-3.

For example, the result transmitted by the server 108 may include information related to the device to perform an operation (e.g., a voice recognition operation, an on-boarding process operation, and the like) based on the voice signal.

The external electronic device 1102-1, external electronic device 2102-2, and/or external electronic device 3102-3 may set each of the external electronic device 1102-1, external electronic device 2102-2, and/or external electronic device 3102-3 to a first mode based on the result received from the server.

The external electronic device 1102-1, external electronic device 2102-2 and/or external electronic device 3102-3 may transmit an information list to the electronic device 101 in the first mode. Alternatively, the external electronic device 1102-1, external electronic device 2102-2, and/or external electronic device 3102-3 may transmit the information list to the electronic device 101 based on whether the user registered in each of the first modes is the same as the user uttering the voice signal.

For example, the result received by the external electronic device 1102-1, external electronic device 2102-2, and/or external electronic device 3102-3 from the server 108 may be substantially identical to a notification signal indicating that the electronic device 101 is in the on-boarding process.

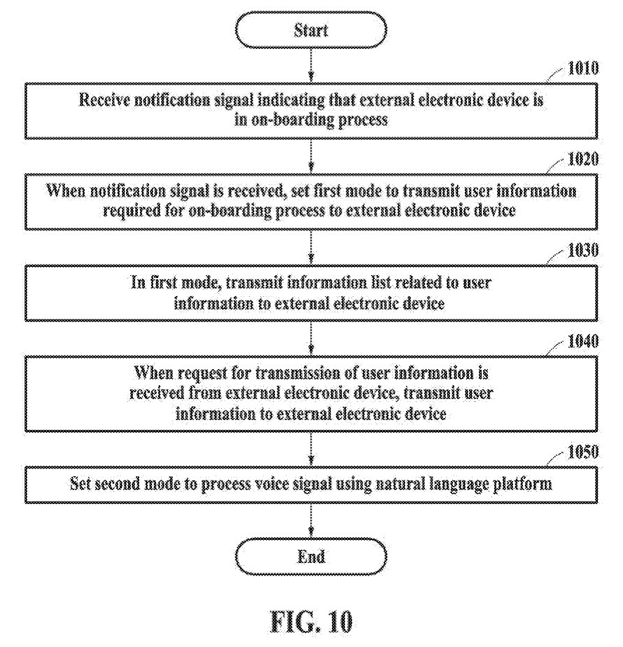

FIG. 10 is a diagram illustrating an operation in which an electronic device (e.g., the electronic device 101, the electronic device 102, and the electronic device 104 of FIG. 1, and the plurality of external electronic devices 102-1, 102-2, and 102-3 of FIG. 5) transmits user information to an external electronic device (e.g., the electronic device 101 of FIGS. 1, 2, 5, 8, and FIG. 9), according to various embodiments.

In operation 1010, the electronic devices 102-1, 102-2, and 102-3 may receive a notification signal indicating that the external electronic device 101 is in an on-boarding process. For example, the electronic devices 102-1, 102-2, and 102-3 may receive a voice signal including a wake up word from a user and identify the wake up word from the voice signal. The electronic devices 102-1, 102-2, and 102-3 may be switched from an inactive state (e.g., a sleep state) to an active state when the wake up word is identified.

For example, the electronic devices 102-1, 102-2, and 102-3 may receive a signal from the external electronic device 101 to change the operating state from an inactive state to an active state, and the operating state may be changed according to the received signal.

The electronic devices 102-1, 102-2, and 102-3 in which the operating state is changed to an active state may receive the notification signal from the external electronic device 101.

When the notification signal is received in operation 1010, in operation 1020, the electronic devices 102-1, 102-2, and 102-3 may set the electronic devices 102-1, 102-2, and 102-3 to a first mode for transmitting information required for the on-boarding process to the external electronic device 101. For example, the first mode may be an operation mode for transmitting user information required for the electronic devices 102-1, 102-2, and 102-3 to the external electronic device 101 during the process of performing the on-boarding of the external electronic device 101. For example, a second mode may be an operation mode in which the electronic devices 102-1, 102-2, and 102-3 process a received voice signal. The operation mode for processing the received voice signal may be an operation mode for processing the voice signal to perform a voice recognition operation and performing an operation according to the recognized voice signal.

The first mode may be distinct from the second mode, and the electronic devices 102-1, 102-2, and 102-3 may perform operations in the first mode that are different from operations in the second mode.

In operation 1030, the electronic devices 102-1, 102-2, and 102-3 may transmit, in the first mode, an information list related to the user information required for the on-boarding process to the external electronic device 101. For example, the information list may include user information stored in the electronic devices 102-1, 102-2, and 102-3, a communication connection scheme (e.g., a network connection scheme) of the electronic devices 102-1, 102-2, and 102-3, a device type, and the like.

In operation 1040, when the electronic devices 102-1, 102-2, and 102-3 receive a request to transmit the user information from the external electronic device 101, the electronic device may transmit the user information to the external electronic device 101. For example, based on the information list received from the electronic devices 102-1, 102-2, and 102-3 and a set policy, the external electronic device 101 may determine the electronic device 102-1, 102-2, or 102-3 to be the device from which to request the user information. When the electronic device 102-1, 102-2, or 102-3 is determined as the device from which to request the user information, the electronic device 102-1, 102-2, or 102-3 may receive a request to transmit the user information from the external electronic device 101. The electronic device 102-1, 102-2, or 102-3 may transmit the requested user information to the external electronic device 101 in response to the transmission request.

In operation 1050, the electronic devices 102-1, 102-2, and 102-3 may set the electronic devices 102-1, 102-2, and 102-3 to the second mode for processing a voice signal using a natural language platform. After transmitting the requested user information to the external electronic device 101 performing the on-boarding process in operation 1040, the electronic devices 102-1, 102-2, and 102-3 may receive a voice signal and change the operation mode to the second mode for recognizing the received voice signal.

An electronic device according to various embodiments (e.g., the electronic device 101 of FIGS. 1, 2, 5, 8, and FIG. 9) may include a processor (e.g., the processor 120 of FIGS. 1 and 2). The processor 120 may receive a voice signal (e.g., the voice signal 510 of FIG. 5) from a user. The processor 120 may transmit a notification signal indicating that the electronic device 101 is in an on-boarding process to a plurality of external electronic devices (e.g., the electronic device 101, the electronic device 102, the electronic device 104 of FIG. 1, and the plurality of external electronic devices 102-1, 102-2, and 102-3 of FIGS. 5, 8, and FIG. 9). The processor 120 may receive an information list related to user information required for the on-boarding process from the plurality of external electronic devices 102-1, 102-2, and 102-3. The processor 120 may determine an external electronic device from which to request the user information among the plurality of external electronic devices 102-1, 102-2, and 102-3, based on the information list and a set policy. The processor 120 may transmit a request to transmit the user information to the determined external electronic device. The processor 120 may receive the user information from the determined external electronic device.

The processor 120 may receive the information list related to the user information based on a result of determining, by the plurality of external electronic devices 102-1, 102-2, and 102-3, whether a user registered in the plurality of external electronic devices 102-1, 102-2, and 102-3 is the same as the user.

The processor 120 may receive the information list from the plurality of external electronic devices 102-1, 102-2, and 102-3 when the user is the same as a user registered in the plurality of external electronic devices 102-1, 102-2, and 102-3.

The processor 120 may transmit a user authentication request to the plurality of external electronic devices 102-1, 102-2, and 102-3 when the user is different from a user registered in the plurality of external electronic devices 102-1, 102-2, and 102-3. The processor 120 may receive the information list related to the user information based on the user authentication according to the user authentication request by the plurality of external electronic devices 102-1, 102-2, and 102-3.

The processor 120 may determine a priority based on a type of the electronic device 101 and types of the plurality of external electronic devices 102-1, 102-2, and 102-3, based on the policy. The processor 120 may determine an external electronic device from which to request the user information according to the priority.

The processor 120 may control a display module (e.g., the display module 160 of FIG. 1) to provide an interface for performing the on-boarding process. The processor 120 may transmit the notification signal based on the voice signal 510 received while providing the interface from the display module 160.

An electronic device according to various embodiments (e.g., the electronic device 101, the electronic device 102, and the electronic device 104 of FIG. 1, the plurality of external electronic devices 102-1, 102-2, and 102-3 of FIGS. 5, 8, and FIG. 9) may include a processor (e.g., the processor 120 of FIGS. 1 and 2). The processor 120 may receive a voice signal (e.g., the voice signal 510 of FIG. 5) from a user. The processor 120 may receive a notification signal indicating that an external electronic device (e.g., the electronic device 101 of FIGS. 1, 2, 5, 8, and FIG. 9) is in an on-boarding process. When the notification signal is received, the processor 120 may be set to a first mode for transmitting user information required for the on-boarding process to the external electronic device 101. The processor 120 may transmit an information list related to the user information to the external electronic device 101 in the first mode. When the processor 120 receives a request to transmit the user information from the external electronic device 101, the processor 120 may transmit the user information to the external electronic device 101.

The electronic devices 102-1, 102-2, and 102-3 may further include a natural language platform (e.g., the natural language platform 220 of FIG. 2) for processing the voice signal 510. The processor 120 may be set to a second mode for processing the voice signal 510 using the natural language platform 220 after transmitting the user information to the external electronic device 101.

The processor 120 may receive the notification signal from the external electronic device 101 or a server that is communicatively connected to the electronic devices 102-1, 102-2, and 102-3.

A method of obtaining user information according to various embodiments may include receiving a voice signal (e.g., the voice signal 510 of FIG. 5) from a user, transmitting a notification signal indicating that an electronic device (e.g., the electronic device 101 of FIGS. 1, 2, 5, 8, and FIG. 9) is in an on-boarding process to a plurality of external electronic devices (e.g., the electronic device 101, the electronic device 102, and the electronic device 104 of FIG. 1, and the plurality of external electronic devices 102-1, 102-2, and 102-3 of FIGS. 5, 8, and FIG. 9), receiving an information list related to user information required for the on-boarding process from the plurality of external electronic devices 102-1, 102-2, and 102-3, based on the information list and a set policy, determining an external electronic device among the plurality of external electronic devices 102-1, 102-2, and 102-3 from which to request the user information, transmitting a request to transmit the user information to the determined external electronic device, and receiving the user information from the determined external electronic device, or a combination thereof.

The receiving of the information list related to the user information may include receiving the information list related to the user information based on a result of determining, by the plurality of external electronic devices 102-1, 102-2, and 102-3, whether a user registered in the plurality of external electronic devices 102-1, 102-2, and 102-3 is the same as the user.

The receiving of the information list related to the user information may include receiving the information list from the plurality of external electronic devices 102-1, 102-2, and 102-3 when the user is the same as a user registered in the plurality of external electronic devices 102-1, 102-2, and 102-3.

The receiving of the information list related to the user information may include transmitting a user authentication request to the plurality of external electronic devices 102-1, 102-2, and 102-3 when the user is different from a user registered in the plurality of external electronic devices 102-1, 102-2, and 102-3. The receiving of the information list related to the user information may include receiving the information list related to the user information based on a user authentication according to the user authentication request by the plurality of external electronic devices 102-1, 102-2, and 102-3.

The determining of the external electronic device from which to request the user information may include determining a priority based on a type of the electronic device 101 and types of the plurality of external electronic devices 102-1, 102-2, and 102-3, based on the policy. The determining of the external electronic device from which to request the user information may include determining the external electronic device from which to request the user information according to the priority.

The method of obtaining the user information may further include controlling a display module to provide an interface for performing the on-boarding process. The transmitting of the notification signal to the plurality of external electronic devices 102-1, 102-2, and 102-3 may include transmitting the notification signal based on the voice signal 510 received while providing the interface in the display module (e.g., the display module 160 of FIG. 1).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, an electronic device includes: memory storing instructions; and at least one processor, wherein the instructions, when executed by the at least one processor, cause the electronic device to: obtain a voice signal from a user; transmit, to a plurality of external electronic devices, a notification signal indicating that the electronic device is in an on-boarding process; obtain, from the plurality of external electronic devices, an information list related to user information for the on-boarding process; identify an external electronic device, among the plurality of external electronic devices, from which to request the user information, based on the information list and a set policy; transmit a request to transmit the user information to the identified external electronic device; and obtain the user information from the identified external electronic device.

According to an embodiment, an electronic device includes: memory storing instructions; and at least one processor, wherein the instructions, when executed by the at least one processor, cause the electronic device to: obtain a voice signal from a user; obtain a notification signal indicating that an external electronic device is in an on-boarding process; based on the notification signal being obtained, set a first mode to transmit user information for the on-boarding process to the external electronic device; in the first mode, transmit an information list related to the user information to the external electronic device; and based on a request to transmit the user information being obtained from the external electronic device, transmit the user information to the external electronic device.

According to an embodiment, a method of obtaining user information includes: obtaining a voice signal from a user; transmitting, to a plurality of external electronic devices, a notification signal indicating that an electronic device is in an on-boarding process; obtaining, from the plurality of external electronic devices, an information list related to user information for the on-boarding process; identifying an external electronic device, among the plurality of external electronic devices, from which to request the user information, based on the information list and a set policy; transmitting a request to transmit the user information to the identified external electronic device; and obtaining the user information from the identified external electronic device.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions; and
at least one processor,
wherein the instructions, when executed by the at least one processor, cause the electronic device to:
obtain a voice signal from a user;
transmit, to a plurality of external electronic devices, a notification signal indicating that the electronic device is in an on-boarding process;
obtain, from the plurality of external electronic devices, an information list related to user information for the on-boarding process;
identify an external electronic device, among the plurality of external electronic devices, from which to request the user information, based on the information list and a set policy;
transmit a request to transmit the user information to the identified external electronic device; and
obtain the user information from the identified external electronic device.

2. The electronic device of claim 1, wherein the instructions, when executed by the at least one processor, cause the electronic device to obtain the information list related to the user information, based on a result of identifying, by the plurality of external electronic devices, whether a user registered in the plurality of external electronic devices is a same user as the user.

3. The electronic device of claim 2, wherein the instructions, when executed by the at least one processor, cause the electronic device to, based on the user being the same user as the user registered in the plurality of external electronic devices, obtain the information list from the plurality of external electronic devices.

4. The electronic device of claim 3, wherein the instructions, when executed by the at least one processor, cause the electronic device to:
based on the user being different from the user registered in the plurality of external electronic devices, transmit a user authentication request to the plurality of external electronic devices; and
obtain the information list related to the user information based on user authentication by the plurality of external electronic devices based on the user authentication request.

5. The electronic device of claim 4, wherein the instructions, when executed by the at least one processor, cause the electronic device to:
identify a priority based on a type of the electronic device and types of the plurality of external electronic devices, based on the set policy; and
identify the external electronic device from which to request the user information, based on the priority.

6. The electronic device of claim 5, wherein the instructions, when executed by the at least one processor, cause the electronic device to:
control a display module (160) to provide an interface for conducting the on-boarding process; and
transmit the notification signal based on the voice signal obtained while the interface is provided in the display module.

7. An electronic device comprising:
memory storing instructions; and
at least one processor,
wherein the instructions, when executed by the at least one processor, cause the electronic device to:
obtain a voice signal from a user;
obtain a notification signal indicating that an external electronic device is in an on-boarding process;
based on the notification signal being obtained, set a first mode to transmit user information for the on-boarding process to the external electronic device;
in the first mode, transmit an information list related to the user information to the external electronic device; and
based on a request to transmit the user information being obtained from the external electronic device, transmit the user information to the external electronic device.

8. The electronic device of claim 7, further comprising:
a natural language platform configured to process the voice signal,
wherein the instructions, when executed by the at least one processor, cause the electronic device to:
after transmitting the user information to the external electronic device, set a second mode to process the voice signal using the natural language platform.

9. The electronic device of claim 8, wherein the instructions, when executed by the at least one processor, cause the electronic device to:
obtain the notification signal from the external electronic device or a server communicatively connected to the electronic device.

10. A method of obtaining user information, the method comprising:
obtaining a voice signal from a user;
transmitting, to a plurality of external electronic devices, a notification signal indicating that an electronic device is in an on-boarding process;
obtaining, from the plurality of external electronic devices, an information list related to user information for the on-boarding process;
identifying an external electronic device, among the plurality of external electronic devices, from which to request the user information, based on the information list and a set policy;
transmitting a request to transmit the user information to the identified external electronic device; and
obtaining the user information from the identified external electronic device.

11. The method of claim 10, wherein the obtaining of the information list related to the user information comprises:
obtaining the information list related to the user information, based on a result of identifying, by the plurality of external electronic devices, whether a user registered in the plurality of external electronic devices is a same user as the user.

12. The method of claim 11, wherein the obtaining of the information list related to the user information comprises:
based on the user being the same user as the user registered in the plurality of external electronic devices, obtaining the information list from the plurality of external electronic devices.

13. The method of claim 12, wherein the obtaining of the information list related to the user information comprises:
based on the user being different from the user registered in the plurality of external electronic devices, transmitting a user authentication request to the plurality of external electronic devices); and
obtaining the information list related to the user information based on user authentication by the plurality of external electronic devices based on the user authentication request.

14. The method of claim 13, wherein the identifying of the external electronic device from which to request the user information comprises:
identifying a priority based on a type of the electronic device and types of the plurality of external electronic devices, based on the set policy; and
identifying the external electronic device from which to request the user information, based on the priority.

15. The method of claim 14, further comprising:
controlling a display module to provide an interface for conducting the on-boarding process,
wherein the transmitting of the notification signal to the plurality of external electronic devices comprises:
transmitting the notification signal based on the voice signal obtained while the interface is provided in the display module.

16. A non-transitory computer readable medium having recorded thereon a program for executing the method of obtaining user information according to claim 10.
